(19) United States
(12) Patent Application Publication
(10) Pub. No.: US 2001/0025246 A1
(43) Pub. Date: Sep. 27, 2001

(54) System and method for providing medication management

(76) Inventors: John Edward Haines, Lantana, FL (US); Linda L. Roman, Boca Raton, FL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/766,525

(22) Filed: Jan. 19, 2001

(51) Int. Cl. G06F 17/60

(52) U.S. Cl. 705/3; 705/2

(57) ABSTRACT

A system and method for providing medication management via use of a network, such as the Internet, is disclosed. Within the system, a patient is diagnosed to determine a patient illness and then prescribed medication to treat the diagnosed patient illness. A medication compliance level of the patient is then determined and the patient's medication usage is managed via the Internet in accordance with the determined medication compliance level of the patient.

### FIELD OF THE INVENTION

The present invention relates generally to patient care, and more particularly, to a system and method for providing medication management to a patient to ensure proper medication usage thereby assisting in obtaining maximum medical results.

### BACKGROUND OF THE INVENTION

With advancements in the medical field, new medications and treatments have been created to treat patient illness. These medications and treatments have but one intended outcome, the return to health of the patient. Alternatively, the goal may be to allow the patient to enjoy a high quality of life, since the return to a truly healthy condition may not be possible.

Medical patients are typically prescribed a number of medications upon proper diagnosis from a care provider, such as, for example, a medical practitioner, a pharmacist, or a nurse. While different medications are prescribed to a patient by a physician in hopes of treating a diagnosed illness, the prescribed medication is only effective if taken by the patient in accordance with a prescribed schedule.

The course of a specific type of illness, treatable by such medication, may in fact be affected by whether a patient remembers to take the prescribed medication in accordance with the prescribed schedule. Further, patients, in general, may simply forget to take the prescribed medication in accordance with the prescribed schedule.

Regular check-ups with a medical practitioner may assist in ensuring that a patient is properly taking a prescribed medication. However, not only are such check-ups relatively expensive and resource intensive, but they typically do not ensure that a patient is properly taking prescribed medication until a significant amount of time has passed. Unfortunately, in certain situations, if a patient is not regularly taking prescribed medication in accordance with a prescription from a certified physician, the prescribed illness may advance to a stage where the benefits of medical treatment no longer exist.

### SUMMARY OF THE INVENTION

In light of the foregoing, the present invention provides a system and method for providing medication management to a patient to ensure proper medication usage and assist in obtaining maximum medical results.

Generally, describing the structure of the management system, the system utilizes a transceiver for receiving and transmitting information associated with medication management, and a processor to perform the functions of, determining a medication compliance level of a patient, and managing the patient's medication usage in accordance with the determined medication compliance level of the patient.

The present invention can also be broadly viewed as providing a method for providing medication management. In this regard, the method can be broadly summarized by the following steps: diagnosing a patient to determine a patient illness; prescribing medication to the patient to treat the diagnosed patient illness; determining a medication compliance level of the patient; and managing the patient's medication usage in accordance with the determined medication compliance level of the patient.

The preferred embodiment of the invention has numerous advantages, a few of which are delineated hereafter as examples. Note that the embodiments of the invention, which are described herein, possess one or more, but not necessarily all, of the advantages set out hereafter.

One advantage of the invention is that it provides a system and method for assuring that a medical patient benefits from prescribed medication while allowing a care provider to more closely, and less expensively, track medication compliance of the patient.

Another advantage is that the invention assists the patient in the development of proper medication compliance habits due to it being customized to the specific needs of a particular patient.

Another advantage is that the invention helps the patient and the care provider manage medication inventories, so there is no break in medication regimen continuity.

Other features and advantages of the present invention will become apparent to one of reasonable skill in the art upon examination of the following drawings and detailed description. It is intended that all such additional features and advantages be included herein within the scope of the present invention, as described by the accompanying claims.

### BRIEF DESCRIPTION OF THE SEVERAL VIEWS OF THE DRAWINGS

The present invention will be more fully understood from the detailed description given below, and from the accompanying drawings of the preferred embodiments of the invention, which, however, should not be taken to limit the invention to the specific embodiments, but are for explanation and for better understanding. Furthermore, the drawings are not necessarily to scale, emphasis instead being placed upon clearly illustrating the principles of the invention.

Finally, like reference numerals in the figures designate corresponding parts throughout the several drawings.

FIG. 1 illustrates a typical Internet based system implementing the medication management system of the present invention.

FIG. 2 is a block diagram that further illustrates the medication management digital processor of FIG. 1.

FIG. 3 is a block diagram that further illustrates the patient digital processor of FIG. 1.

FIG. 4 is a block diagram that illustrates the location of data used in association with the medication management system of FIG. 1.

FIG. 5 is a flow chart illustrating the architecture, functionality, and operation of one example of a configuration process performed to enable use of the medication management system of FIG. 1.

FIG. 6 illustrates a sample medication information screen that may be provided to a care provider via the medication management digital processor of FIG. 1, for allowing the care provider to specify particular information regarding a prescribed medication.

FIG. 7 illustrates an example of a possible medication information editing screen for use in connection with the medication management system of FIG. 1.

### DESCRIPTION OF THE PREFERRED EMBODIMENTS

The medical management system of the present invention can be implemented in software, firmware, hardware, or a combination thereof. In the preferred embodiment of the invention, which is intended to be a non-limiting example, the medical management system is implemented in both hardware and software. The software portion of the system is executed by a computer, for example, but not limited to, a personal computer, workstation, mini computer, or mainframe computer.

The software portion of the medical management system, which comprises an ordered listing of executable instructions for implementing logical functions, can be embodied in any computer-readable medium for use by, or in connection with, an instruction execution system, apparatus, or device such as a computer-based system processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus or device. The computer-readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disk read-only memory (CD ROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner, if necessary, and then stored in a computer memory.

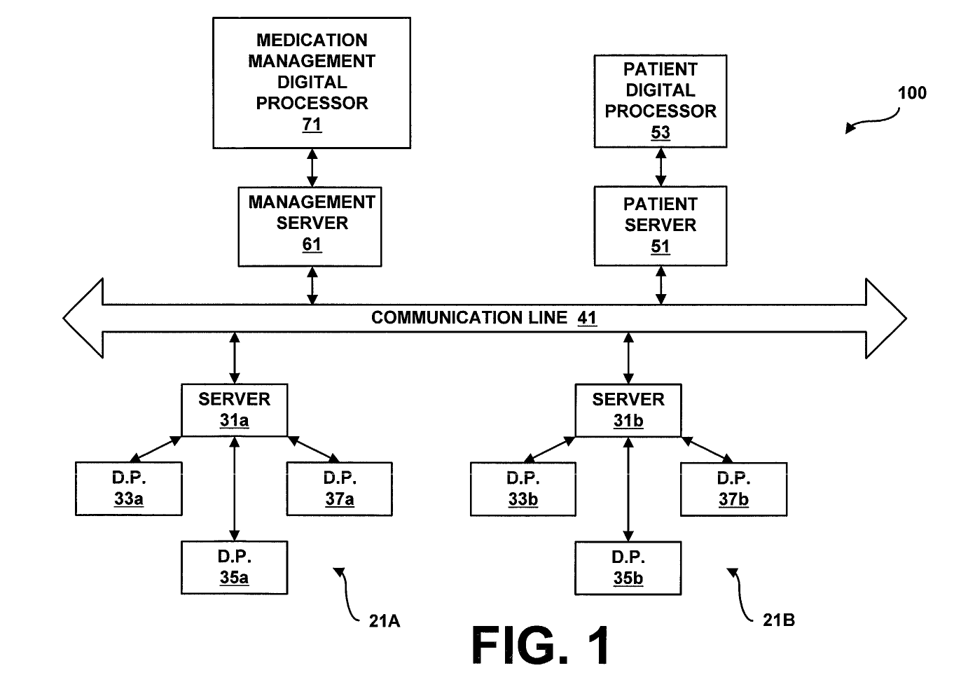

By way of example and illustration, FIG. 1 illustrates a typical Internet based system that implements the medication management system 100 of the present invention. It should be noted that while the present disclosure provides implementation of the medication management system 100 within an Internet based system, the medication management system 100 need not be provided via use of a network, such as the Internet. Instead, one of reasonable skill in the art will appreciate that the medication management system 100 may be implemented in connection with other mediums, such as, for example, but not limited to, a local area network (LAN) or wide area network (WAN). Alternatively, instead of implementing the medication management system via use of the Internet, the medication management system may also be implemented via use of a first transmitting and receiving device such as, but not limited to, a modem located at a patient's location, which is in communication with a second transmitting and receiving device such as, but not limited to, a modem located at a care provider's location. In accordance with such an embodiment, personal computers, may be located at the patient's location and the care provider's location having logic provide therein to perform functions in accordance with the medical management system 100.

Furthermore, in accordance with an alternate embodiment of the invention, the medication management system 100 may instead utilize a multi-point control unit (MCU), instead of a personal computer, wherein video conferencing systems located at several locations may be interconnected for conferencing between patients and a care provider, as described hereinbelow. As known in the art, to initiate a conference using the MCU, a user simply dials a number containing a predefined service prefix and a conference identifier. The MCU then automatically sets up the conference. Users at other locations may then join the conference by dialing the same number for instantaneous connection.

Referring to FIG. 1, a plurality of networks 21a, 21b are shown wherein each network 21 includes multiple digital processors 33, 35, 37. Digital processors 33, 35, 37 within each network 21 may include, but are not limited to, personal computers, mini computers, laptops, and the like. Each digital processor 33, 35, 37 is typically coupled to a host processor or server 31a, 31b for communication among processors 33, 35, 37 within the specific corresponding network 21.

The host processor, or server, 31 is coupled to a communication line 41 that interconnects or links the networks 21a, 21b to each other, thereby forming an Internet. As such, each of the networks 21a, 21b are coupled along the communication line 41 to enable access from a digital processor 33a, 35a, 37a of one network 21a to a digital processor 33b, 35b, 37b of another network 21b.

A patient server 51 is linked to the communication line 41, thus providing a patient with access to the Internet via a patient digital processor 53, as further described hereinbelow. In accordance with the preferred embodiment of the invention, the software for implementation of the medication management system 100 is provided by a software program that is operated and located on a medication management digital processor 71, and connected through a management server 61, to the communication line 41 for communication among the various networks 21a, 21b and/or digital processors 33, 35, 37 and the patient connected to the Internet via the patient server 51.

It should be noted that the number of patient servers, digital processors, medication management digital processors, and management servers may differ in accordance with the number of patients and/or care providers provided for by the present medication management system 100. As an example, if five separately located patients were utilizing the medication management system 100, five separate patient digital processors may be connected to a single patient server, or five separate patient servers. Further, depending on the number of care providers and their locations, there may be anywhere from one to five medication management digital processors, and from one to five management servers.

In accordance with the preferred embodiment of the invention, the patient digital processor 53 may be any device, such as, but not limited to, a personal computer, laptop, workstation, or mainframe computer, which provides the patient with video, audio, and text capabilities as well as data storing capabilities. These capabilities provide each patient with the ability to see, hear, and speak with care providers, as described in detail hereinbelow. Further, the networks used by the medication management system 100 are preferably secure and encrypted for purposes of ensuring the confidentiality of information transmitted within and between the networks 21a, 21b.

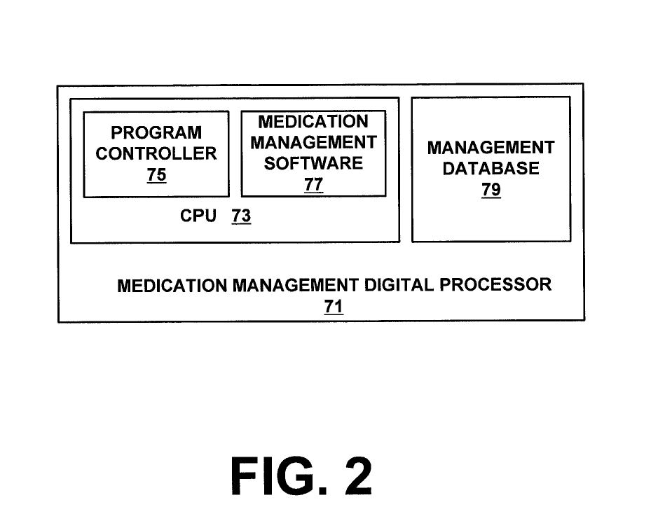

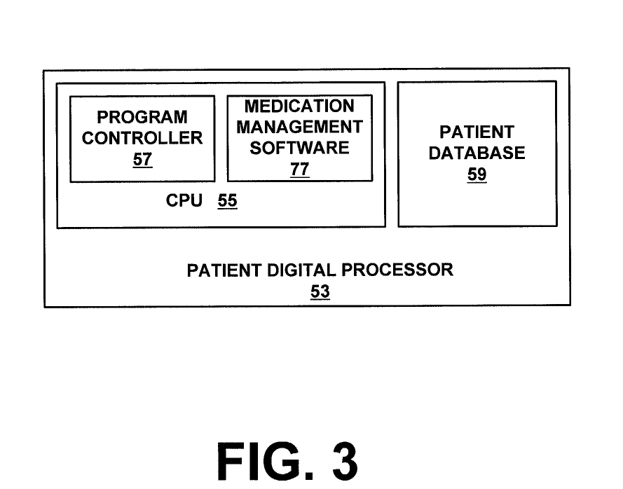

FIG. 2 is a block diagram that further illustrates the medication management digital processor 71 of FIG. 1. As shown by FIG. 2, the medical management digital processor 71 comprises a central processing unit (CPU) 73 having a program controller 75 and medication management software 77 stored therein. The program controller 75 is capable of performing functionality required by the medication management system 100, as specified by the medication management software 77. The medication management digital processor 71 also comprises a management database 79 for storing medical data as described hereinbelow. Preferably, data stored within the management database 79 is stored in tabular form where the data stored within each table is stored within blocks of data cells identified by field names, as described in detail with reference to FIG. 3. The locating and updating of data, as required by the medication management system 100, is performed by the program controller 75.

FIG. 3 is a block diagram that further illustrates the patient digital processor 53 of FIG. 1. As shown by FIG. 3, the patient digital processor 53 comprises a central processing unit (CPU) 55 having a program controller 57 and the medication management software 77. The program controller 57 is capable of performing functionality required by the medication management system 100, as specified by the medication management software 77. The patient digital processor 53 also comprises a patient database 59, which may store any portion of patient's medical information as described hereinbelow. Locating and updating of data within the patient digital processor 53, as required by the medication management system 100, is performed by the program controller 57.

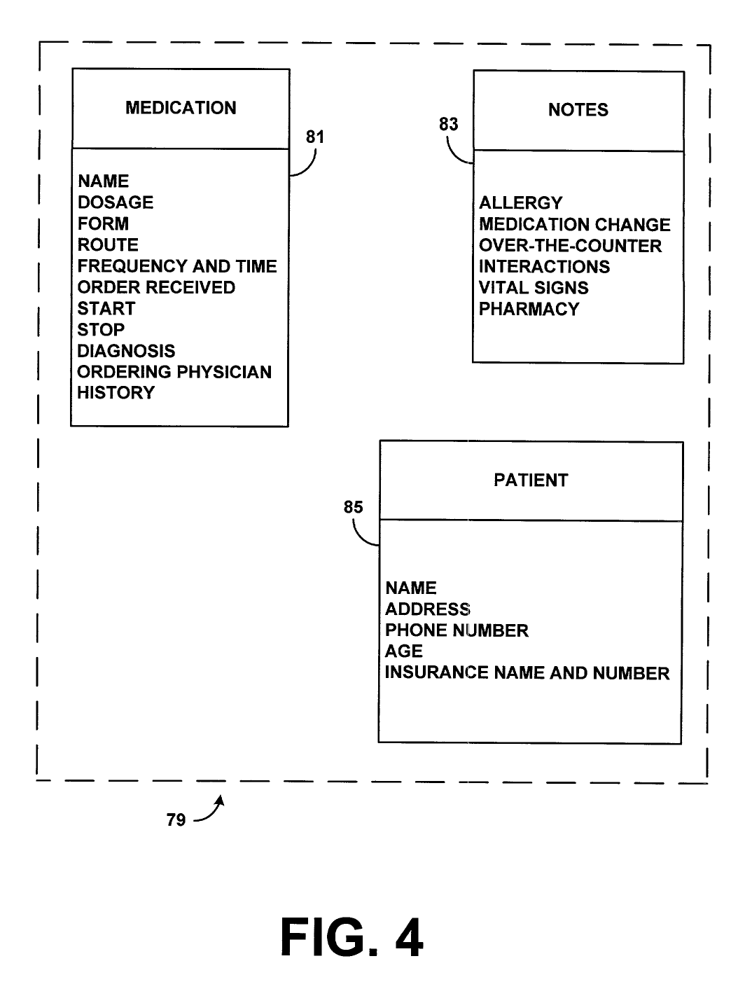

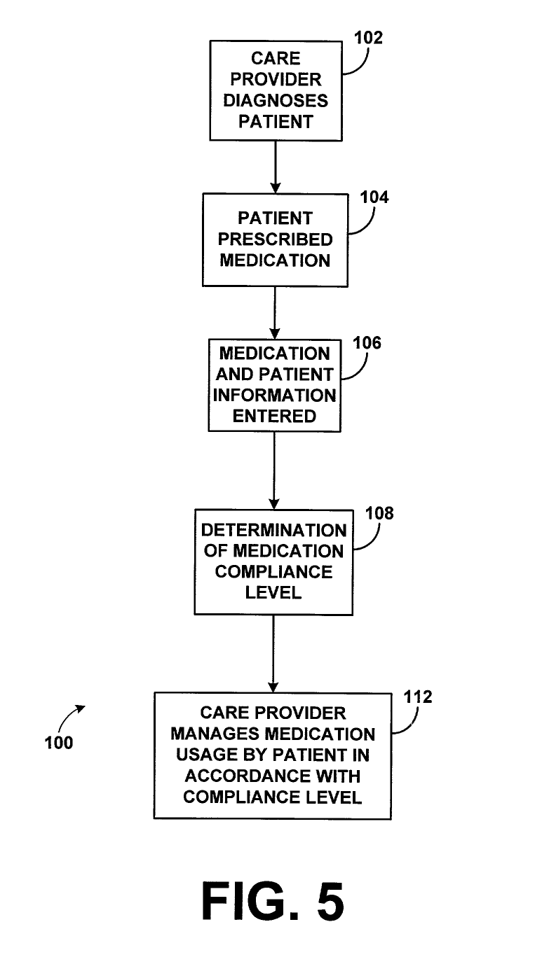

FIG. 4 is a block diagram that illustrates the location of data used in association with the present medication management system 100. The obtaining and use of the stored data is described with reference to FIG. 5, described in detail hereinbelow. It should be noted that while the following description provides location of data within the medication management digital processor 71, one of ordinary skill in the art will appreciate that any portion of the data may be stored distant to the medication management digital processor 71. Further, while the data stored within the management database 79 is preferably stored in tabular form wherein each table is identified by a field name, the data need not be stored in tabular form.

In accordance with the preferred embodiment of the invention a medication table 81 is provided within the management database 79 which stores information regarding prescribed patient medication. A first field used within the medication table 81 is a medication name field. Data categorized under the medication name field includes the proper name of the medication prescribed to a patient. In accordance with the preferred embodiment, a listing of known medications is stored within the management database 79 (FIG. 2) such that a medication prescribed to a patient may be selected from a medication name list by selecting from a pulldown menu presented to the care provider within a screen view. Selection of medications taken by a patient then results in the medication name being flagged for future viewing, as described in detail hereinbelow. Alternatively, logic may be stored within the medication management system 100 such that a care provider may enter the beginning letters of a prescribed medication, and the entire medication name is presented to the care provider for selection.

A second field within the medication table 81 is a dosage field. Data categorized under the dosage field may include, but is not limited to, the dosage of medication prescribed by a physician to the patient for treatment of an illness. In accordance with the preferred embodiment, a listing of medication dosages is stored within the management database 79 (FIG. 2) such that a prescribed dosage to a patient may be selected from a medication dosage list by selecting from a pulldown menu presented to the care provider within a screen view. Selection of the medication dosage taken by a patient then results in the medication dosage being flagged for future viewing, as described in detail hereinbelow. Alternatively, logic may be stored within the medication management system 100, such that a care provider may enter a medication name, and the correct dosage is presented to the care provider for selection.

A third field used within the medication table 81 is a form field. Data categorized under the form field may include, for example, but not limited to, information regarding the form of physician prescribed medication. As an example, a prescribed medication may be in the form of a tablet, liquid, powder, or inhalant. In accordance with the preferred embodiment, a listing of known medication forms is stored within the management database 79 (FIG. 2) such that a form of medication prescribed to a patient may be selected from a list of forms by selecting from a pulldown menu presented to the care provider within a screen view. Selection of the form of medication taken by a patient then results in the form of medication being flagged for future viewing, as described in detail hereinbelow. Alternatively, logic may be stored within the medication management system 100 such that a care provider may enter the medication, and the medication form is presented to the care provider for selection.

A fourth field used within the medication table 81 is a route field. Data categorized under the route field may include, but is not limited to, the method used by a patient to introduce the medication into their body. As an example, the route field may state that a particular medication is to be taken via the nose, as an inhalant, or via the mouth as a liquid. In accordance with the preferred embodiment, a listing of known routes is stored within the management database 79 (FIG. 2) such that a medication route prescribed to a patient may be selected from a medication route list, by selecting from a pulldown menu presented to the care provider within a screen view. Selection of a medication route taken by a patient then results in the medication route being flagged for future viewing, as described in detail hereinbelow. Alternatively, logic may be stored within the medication management system 100 such that a care provider may enter prescribed medication, resulting in the medication route being presented to the care provider for selection.

A fifth field used within the medication table 81 is a frequency and time field. Data categorized under the frequency and time field may include, but is not limited to, the frequency which prescribed medication, identified within the medication name field, should be taken by the patient. Based upon the frequency of medication usage, a scheduled medication usage plan is developed showing times within a prescribed period for the prescribed medication to be taken. As an example, if the frequency of medication usage is twice daily, a time schedule of 8 A.M. and 3 P.M. may be stored within the frequency and time field for future use by the medication management system 100.

A sixth field used within the medication table is an order-received field. Data categorized under the order received field may include, but is not limited to, the date in which a patient receives a prescribed medication, the name of which is identified with reference to the medication name field hereinabove. As shown hereinbelow, the date order received field may be used to ensure that a patient does not run out of a prescribed medication.

A seventh field and an eighth field used within the medication table 81 are a start field and a stop field. Preferably, the start and stop date fields store data which identify the start and stop dates, respectively, for a patient to take a specific prescribed medication, as identified by the medication name field provided hereinabove.

A ninth field used within the medication table is a diagnosis field. Data categorized under the diagnosis field may include, but is not limited to, information regarding a physician's diagnosis of a patient, such as, for example, the name of the illness treated by the medication identified within the medication name field.

A tenth field used within the medication table is an ordering physician field, which identifies the physician that ordered the prescribed medication for the patient. Preferably, the ordering physician's place of business, home address, work address, home telephone number, work telephone number, and the date on which the ordering physician ordered a prescription for the patient is provided within the ordering physician field.

An eleventh field used within the medication table is a history field. Data categorized under the history field may include, but is not limited to, information regarding the ordering history of the prescribed medication, including, but not limited to, previous dosages, and other previous medication information such as reactions to previous medications.

A second table located within the management database 79 is a notes table 83 on which is stored specific medication notes regarding a patient in order to better provide care for such patients. A first field used within the notes table is an allergy field. Data categorized under the allergy field may include, but is not limited to, data summarizing an original assessment of present and potential allergies possessed by a diagnosed patient. Further, the allergy field may store information regarding, any allergic reactions a patient may have to specific prescribed medications. Still further, information stored within the allergy field may include information regarding specific prescriptions which may not be taken by a patient due to specific allergies the patient may have.

A second field used within the notes table 83 is a medication change field. Data categorized under the medication change field may include, but is not limited to, notes regarding prescribed medication changes received from a physician or care provider's office. Further, the medication change field may be used directly by the physician or care provider in order to change a patient's prescription. The changed prescription may also be viewed by the patient, and ordered, as explained in detail hereinbelow.

A third field used within the notes table 83 is an over-the-counter field. Data categorized under the over-the-counter field may include, but is not limited to, the name of over-the-counter medications presently being taken by a patient. Information regarding possible interactions between over-the-counter products and prescribed prescriptions may also be stored within the over-the-counter field.

A fourth field used within the notes table 83 is an interactions field. Data categorized under the interactions field may include, but is not limited to, notes regarding possible food and drug interactions and possible drug and drug interactions. These interactions may come from a pharmaceutical database, which may be imbedded within the medication management software 77. As such, when a patient's medications are entered, the medication database 79 can be cross-checked to determine whether there are potentially harmful food and drug interactions or drug and drug interactions that may occur due to the prescribed medication.

A fifth field used within the notes table 83 is a vital signs field. Data categorized under the vital signs field may include, but is not limited to, information such as a patient's laboratory results, and vital signs. In addition, notes may also be stored within the vital signs field regarding changes in vital signs measured as a result of medication usage.

A sixth field used within the notes table 83 is a pharmacy field. Data categorized under the pharmacy field may include, but is not limited to, pertinent information regarding a pharmacy which has been used by an ordering physician, or care provider to obtain medication for a patient. This information may include, the pharmacy's name, address, telephone number, and a date to reorder the prescribed prescription.

A third table located within the medication database 79 is a patient table 85 on which is stored specific information identifying the patient. Fields used within the patient table 85 may include a name table, an address table, a telephone number table, an age table, and an insurance name and number table. Since each of the aforementioned tables are self explanatory due to their titles, further explanation of each table is not offered herein.

FIG. 5 is a flow chart illustrating the architecture, functionality, and operation of one example of a configuration process performed to enable use of the medication management system 100. With regard to the flow chart of FIG. 5, each block represents a module, segment, or portion of code, which comprises one or more executable instructions for implementing the specified logical function(s). It should also be noted that in some alternate implementations, the function(s) noted in the blocks may occur out of the order noted. For example, two blocks shown in succession may in fact be executed substantially concurrently, or the blocks may sometimes be executed in the reverse order, depending upon the functionality involved.

Referring to FIG. 5, as shown by block 102, a physician or care provider first meets with a patient for purposes of diagnosing the patient and determining whether a specific illness exists, the symptoms of which may be treated by a prescribed medication. As shown by block 104, in accordance with the aforementioned medical analysis, the patient is prescribed at least one medication for purposes of providing medical treatment for the patient's diagnosed illness.

As shown by block 106, after a medical prescription has been provided to the patient, a care provider enters information regarding the prescribed medication and the patient to the medication management system 100, via their medication management digital processor 71. Examples of information that may be entered by a care provider includes the patient's name, address, telephone number, age and prescription insurance information.

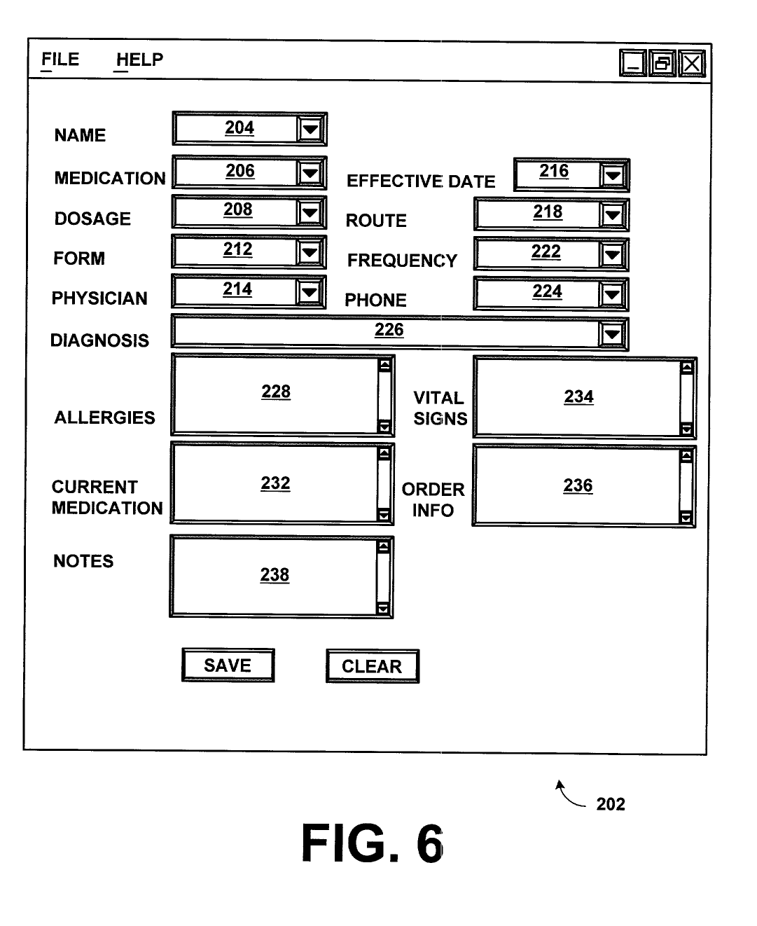

FIG. 6 illustrates a sample medication information screen 202 which may be provided to the care provider via the medication management digital processor 71 for allowing the care provider to specify particular information regarding a prescribed medication. As shown by FIG. 6, a patient's name may be entered within a name block 204 located within the medication information screen 202. In accordance with an alternative embodiment of the invention, a list of the names of patients currently being treated by the care provider or physician may be previously stored within the management database 79 (FIG. 2). As a result, a pull down screen may be provided by the alternative embodiment wherein a care provider may select from a list of stored patient names.

The care provider may enter the type of medication prescribed to the patient within a medication block 206. Alternatively, a list of medications commonly prescribed by the care provider may be stored within the management database 79 (FIG. 2), such that the care provider may select a prescribed medication from a pull down menu. Logic may also be available such that when a care provider enters the beginning letters, or numerals, of a specific medication, the remaining portion of the medication name is presented to the care provider, such that the care provider is not required to enter the entire prescribed medication's name.

The required dosage prescribed by the care provider may be specified within a dosage block 208 located within the medication information screen 202. The dosage amount may alternatively be selected via a pull down menu in accordance with predefined dosage portions stored within the management database 79 (FIG. 2). The form of the prescribed medication may be specified by the care provider within a form block 212 located within the medication information screen 202. Alternatively, specific categories of form may be previously stored within the management database 79 (FIG. 2) such that the care provider may select the form of medication from a pull down menu. Such forms of medication may include, but are not limited to, capsules, tablets, liquids, inhalants, and injections.

The prescribing physician may be specified by the care provider within a physician block 214 located within the medication information screen 202. Alternatively, the names of physicians known by the care provider may be stored within the management database 79 (FIG. 2) prior to entry by the care provider. As such, the care provider may select a physician's name from a pull down menu located within the medication information screen 202.

The effective date of prescription provided by the physician to the patient may also be entered within the medication information screen 202 via an effective data block 216. The effective date of prescription may also be selected by the care provider via a pull down menu located within the medication information screen 202.

The care provider may also provide the route prescribed to the patient for proper prescribed medication usage via a route block 218. Logic may be provided within the medication management software 77 such that, when the medication name is provided by the care provider, the preferred route of usage appears within the route block 218. Alternatively, the route of medication usage may be selected from a pulldown menu.

The frequency of which the prescribed medication should be taken by the patient may be specified by the care provider within a frequency block 222 located on the medication information screen 202. The frequency of medication may be entered in any known form of medication usage. As an example, the medication frequency may be entered as “daily,” “four times daily,” “hourly,” or in accordance with any other prescribed time schedule. Alternatively, the medication frequency may be predefined within the management database 79 (FIG. 2) such that the care provider may select a specific medication frequency from a pull down menu.

The patient's telephone number may also be entered within the medication information screen 202 within a telephone block 224. It should be noted that other forms of identification, such as, but not limited to, electronic mail (e-mail), social security number, and/or home address, may be entered within the medication information screen 202.

A medical diagnosis provided by a physician may be entered by the care provider within the medication information screen 202 via a diagnosis block 226. Information entered within the diagnosis block 226 may vary in accordance with the physician providing such information to the care provider. Alternatively, specific categories of diagnosis may be predefined within the management database 79 (FIG. 2) such that a care provider may select the diagnosis of the patient from a selection within a pull down menu within the medication information screen 202.

Patient allergies may be specified within the medication information screen 202 within an allergies block 228. Alternatively, a listing of different allergies may be predefined within the management database 79 (FIG. 2) such that a care provider may select specific allergies possessed by the patient by using a pull down menu.

Any medication which the patient is taking at the time of prescription by the physician may be entered within the medication information screen 202 within a current medication block 232. The medication management software 77 (FIG. 2) may contain logic such that potential medical conflicts between currently taken medications and prescribed medication by the physician will invoke an alarm to the care provider entering such information within the medication information screen 202. Alternatively, a listing of medications commonly known by the care provider may be predefined within the management database 79 (FIG. 2) such that the physician may select a specific medication from a pull down menu.

The vital signs of the patient at the time of prescription by the physician may also be specified within the medication information screen 202 within a vital signs block 234. Such vital signs may include, but are not limited to, blood pressure, cholesterol level, and body temperature.

Medication ordering information may also be provided within the medication information screen 202. Specifically, information entered within an ordering information block 236 may include, but is not limited to, the name of a pharmacy used by the patient or care provider for ordering the prescribed medication, the pharmacy's address and telephone number, and a specific date at which time the prescribed medication should be reordered.

Miscellaneous notes may be provided within the medication information screen 202 within a notes block 238. Specifically, information entered within the notes block 238 may include, but is not limited to, information regarding a patient and the patient's treatment.

In accordance with the preferred embodiment of the invention, an event log is used by the medication management system 100 such that a clear audit trail may be produced including all modifications, changes or other alterations to a patient's medication prescriptions and records, as well as who changed the records or prescription and at what time such changes were made. Further, data entry confirmation logic may be used by the medication management system 100 to prevent unintentional errors from being made in entering information within the medication information screen 202. Methods of data entry confirmation are known within the art and therefore are not discussed in detail herein.

Returning to FIG. 5, after the aforementioned medical information is entered, as an example, within a medical information screen 202, a patient's level of medication compliance is determined in order to ensure that the patient receives maximum health benefits from prescribed medication (block 108).

To determine a level of medication compliance, medication compliance questions are presented by the medication management system software 77 (FIG. 2) and answered by either a physician or care provider, which assess a medical patient's probability of properly taking prescribed medication. Examples of medication compliance levels are listed hereinbelow.

Medication compliance level 0 is assigned to medical patients that have no medication compliance issues. Specifically, if a medical patient receives a medication compliance level of 0 then there is no intervention necessary in the patient's taking of prescribed medication.

If a medication compliance level of 1 is awarded to a patient, the patient is to signify the taking of a prescribed medication at the time of medication usage via the patient digital processor 53 (FIG. 1). When the patient signifies the usage of the prescribed medication, the date and time of medication usage is recorded by the medication management system 100 (FIG. 1). Preferably, this date and time may be stored within both the management database 79 (FIG. 2) and the patient database 59 (FIG. 3) for future use and reference, as described hereinbelow. In addition, an image of the medication to be taken by the patient may be displayed to the patient to ensure accuracy of medication usage.

In accordance with an alternate embodiment of the invention, the patient's digital processor 53 (FIG. 1) is provided with touch-screen capability wherein a patient may touch a screen when taking medication, thereby resulting in the patient digital processor 53 (FIG. 1) recording the date and time of medication usage.

If a patient receives a level 2 medication compliance the patient receives a reminder to take the prescribed medication in accordance with a predetermined time schedule. This reminder may be received by the patient via data transmission such as e-mail, or live text, or the patient may receive a reminder via the video capability of the patient digital processor 53 (FIG. 1) such that a live video conference is held between a physician or care provider, and the patient. As in level 1, patients having a medication compliance of level 2 are also required to specify when they take a prescribed medication at the time of medication usage, via their digital processor 53 (FIG. 1).

A patient receiving a medication compliance level of 3 receives a live one-on-one call, via either audio, video, or both audio and video, and is required to specify when they take a prescribed medication at the time of medication usage.

When an observing care provider has knowledge sufficient to conclude that the patient has taken the prescribed medication, the care provider makes an entry into the medication management software 77 (FIG. 2) acknowledging the medication event.

The following provides an example of medical compliance questions that may be asked to a care provider in determining whether a patient has a medication compliance level of 0, 1, 2, or 3. It should be noted that different questions may be asked and answered in determining the medication compliance level of a patient.

I. the patient demonstrates non-compliance due to:

A. inadequate resources-4

B. inadequate motiviation-4

C. inadequate knowledge/understanding-4

D. other-3

E. none-0

II. management of oral medications:

A. no oral medications prescribed-0

B. unable to take medications unless administered by someone else-5 does the patient have someone to assist with medications?

a. no—not a candidate for program

b. yes—specify

C. able to independently take the correct oral medication(s) and proper dosage(s) at the correct time-1

D. able to independently take the correct medication(s) and proper dosage(s) if: individual dosages are prepared in advance or given daily reminders or someone develops a drug diary or chart-5

III. Management of inhalant/mist medications: (current)

A. no oral medications prescribed-0

B. unable to take medication unless administered by someone else-5 does the patient have someone to assist with medication?

a. no—not a candidate for program

b. yes—specify

C. able to independently take the correct oral medication(s) and proper dosage(s) at the correct time-1

D. able to independently take correct inhalant/mist medication(s) and proper dosage(s) at the correct time if: individual dosages are prepared in advance or given daily reminders or someone develops a drug diary or chart-4

IV. management of injectable medications: (current)

A. no injectable medications prescribed-0

B. unable to take medication unless administered by someone else-5 does the patient have someone to assist with medication?

a. no—not a candidate for program

b. yes—specify

C. able to independently take the correct injectable medication(s) and proper dosage(s) at the correct time-1

D. able to independently take correct injectable medication(s) and proper dosage(s) at the correct time if: individual dosages are prepared in advance or given daily reminders or someone develops a drug diary or chart-4

V. does the patient take more than 8 medications (including over the counter)

A. yes-3

B. no-1

VI. does the patient believe that the side effects/risks of the medication he/she has been prescribed out weigh the benefits

A. yes-4

B. no-1

VII. should a medication simplification plan (dosage and scheduling) be considered for this patient

A. yes-5

B. no-0

Determination of a patient's medication compliance may then be calculated in accordance with the following range of scores.

Level 0: 0-4

Level 1: 5-10

Level 2: 11-15

Level 3: greater than 15

In accordance with the preferred embodiment of the invention, patients may be moved to a higher or lower compliance level at the care provider's discretion.

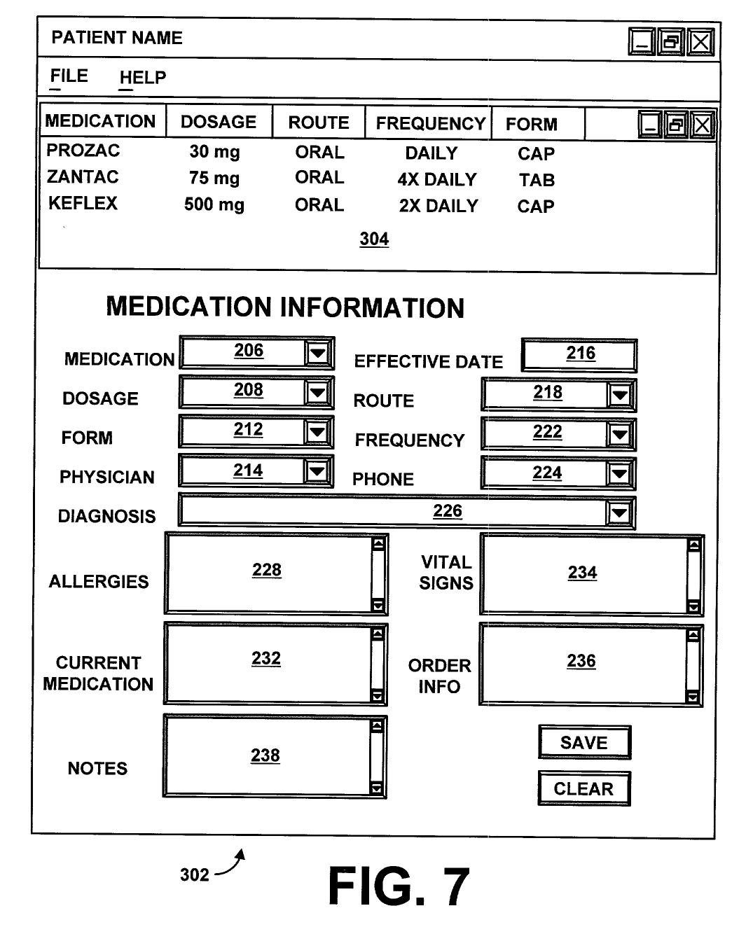

Returning to FIG. 5, after determining a medication compliance level for the patient (block 108), the care provider manages the prescribed medication usage of the patient in accordance with their medication compliance level (block 112). Editing of a patient's medical information may also be performed. An example of a possible medication information editing screen 302 is illustrated by FIG. 7. As in FIG. 6, blocks medication 206, dosage 208, form 212, physician 214, effective date 216, route 218, frequency 222, telephone 224, diagnosis 226, allergies 228, current medication 232, vital signs 234, order information 236 and notes 238 are located within the information editing screen 302. The medication information editing screen 302 also provides a summary window 304 containing a summary of medications the patient is presently taking, including the dosage, route, frequency, and form of the medication.

The care provider may select different patient records to view via a “file” tab located on a view screen. As known in the art, the “file” tab allows the care provider to open separate file folders that may be stored local to the management database 79 (FIG. 2). As patient medical information is updated, the care provider may save edited information within the management database 79 (FIG. 2) for future reference and/or use in medical diagnosis. Preferably, the patient's medical compliance level is tested with relative frequency, such that the best medical treatment is always provided to the patient based on the patient's actions and medical performance.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for providing medication management, comprising:
a transceiver;
a memory communicable coupled to said transceiver, having software defining functions to be performed by said system;
a processor configured by said software in said memory to perform the functions of:
determining a medication compliance level of a patient; and
managing medication usage of said patient in accordance with said determined medication compliance level of said patient.

2. The system of claim 1, wherein said determination of a medication compliance level of a patient is performed via use of information received by said first transceiver.

3. The system of claim 1, wherein said transceiver allows a care provider to assist in managing said medication usage of said patient.

4. The system of claim 1, wherein said processor performs said function of determining a medication compliance level repetitiously, in accordance with a predetermined schedule, and wherein said managing said patient's medication usage is performed according to differences in said compliance level.

5. The system of claim 1, wherein said transceiver communicates via the Internet.

6. The system of claim 1, wherein said memory and processor are located within a computer that is located within a local area network.

7. The system of claim 1, wherein said determining a medication compliance level is performed via use of a series of questions, the answers to which comprise a point value, wherein use of said point value provides said medication compliance level.

8. The system of claim 1, wherein said managing said patient's medication usage includes monitoring said medication usage and requesting replacement of said medication based upon a remaining amount of said medication and a predefined level.

9. The system of claim 8, wherein said requesting replacement of said medication is performed via said transceiver.

10. A method for providing medication management, comprising the steps of:
diagnosing a patient to determine a patient illness;
prescribing medication to said patient to treat said diagnosed patient illness;
determining a medication compliance level of said patient; and
managing medication usage of said patient in accordance with said determined medication compliance level of said patient.

11. The method of claim 10, further comprising the step of adjusting said management of said patient's medication usage, after repetition of said determining step, which is performed after a predetermined period.

12. The method of claim 10, wherein said step of managing said patient's medication usage is performed via use of the Internet.

13. The method of claim 10, wherein said step of managing said patient's medication usage is performed via a computer network.

14. The method of claim 10, wherein said step of determining a medication compliance level is performed via use of a series of questions, the answers to which comprise a point value, wherein use of said point value provides said medication compliance level.

15. The method of claim 10, wherein said step of managing said patient's medication usage further comprises the step of monitoring said medication usage, and requesting replacement of said medication when a remaining amount of said medication has gone below a predefined level.

16. The method of claim 10, wherein said step of determining a medication compliance level is performed by a care provider while said patient is visiting the care provider's facilities.

17. A system for providing medication management, comprising:
means for diagnosing a patient to determine a patient illness;
means for prescribing medication to said patient to treat said diagnosed patient illness;
means for determining a medication compliance level of said patient; and
means for managing the medication usage of said patient in accordance with said determined medication compliance level of said patient.

18. The system of claim 17, further comprising means for adjusting said management of said patient's medication usage, which adjusts said management of said patient's medication usage after said means for determining a medication compliance level repeats determination of a medication compliance level, after a predetermined period.

19. The system of claim 17, wherein said means for managing said patient's medication usage manages via use of the Internet.

20. The system of claim 17, wherein said means for managing said patient's medication usage manages via use of a computer network.

21. The system of claim 17, wherein said means for determining a medication compliance level uses a series of questions, the answers to which comprise a point value, wherein use of said point value provides said medication compliance level.
